(19) United States
(12) Patent Application Publication
(10) Pub. No.: US 2015/0230451 A1
(43) Pub. Date: Aug. 20, 2015

(54) Method And Apparatus For Force Transfer And Mounting Of Pest Repellents

(71) Applicant: William D. Nicholson, Waukesha, WI (US)

(72) Inventors: William D. Nicholson, Waukesha, WI (US); Christopher Ehlers, Waukesha, WI (US)

(73) Assignee: William D. Nicholson, Waukesha, WI (US)

(21) Appl. No.: 14/620,812

(22) Filed: Feb. 12, 2015

Related U.S. Application Data
(60) Provisional application No. 61/940,145, filed on Feb. 14, 2014.

(51) Int. Cl. A01M 29/22; F16M 13/02

(52) U.S. Cl. CPC A01M 29/22; F16M 13/02

(57) ABSTRACT

An apparatus, method, and mounting apparatus repel pests from an object. A vibration generator is operable to produce a plurality of vibrations. A mounting apparatus secures the vibration generator to the object from which the pests are to be repelled. The mounting apparatus transfers the plurality of vibrations from the vibration generator to the object. The plurality of vibrations transferred to the object from the vibration generator repels pests from the object.

### CROSS REFERENCE TO RELATED APPLICATION

This application relates to and claims priority from U.S. Provisional Application Ser. No. 61/940,145 filed on Feb. 14, 2014 which is hereby incorporated by reference in its entirety.

### FIELD OF THE INVENTION

The present disclosure is in the field of the mounting of devices that apply a force or generate movement in a plant, tree, branch or other medium. U.S. patent application Ser. No. 13/754,132, filed on Jan. 30, 2013 and entitled “Apparatus and Method of Repelling Unwanted Pests”, which is hereby incorporated by reference in its entirety, discloses exemplary embodiments of a vibration generator. Other device which can vibrate may also be vibration generators. Such vibrations can be transferred to plant, tree, or branch.

Pests come in various types and sizes. Pests may include insects, animals, birds and in some cases children or people in unwanted areas of yards or houses or any other building. Fences, chemicals and other means used to control or kill pests are often dangerous or cumbersome to humans.

Today many new insects have invaded areas not formally inhabited by their species. Some insects like Japanese beetles, Box Elders bugs, mosquitoes and ants are often difficult at best to control with pesticides. They have become a plague in many areas and are spreading rapidly across the United States. They often invade fruits and vegetable plants that are difficult to spray with chemicals, especially close, to harvest time. Some insects often sit on the warm sides of houses or structures and plants and gravitate to warm openings in fall. With the advent and growth of organic gardening, pesticide use may not be desired or may be prevented all together.

Pests are not limited to insects. Chemicals may not be effective against some pests such as birds (robins) who eat cherries out of cherry trees as they ripen. Birds often find favorite places to perch that are destructive to the items being perched on. Destructive and dangerous places to perch include power lines and other places where the birds may interrupt service. Often birds leave fecal matter in all sorts of places where they perch that destroy the esthetic look of the place where perched. Some examples of common places soiled by birds include windows, doors, mail boxes, lights, landscaping lights, fences, antennas, cars, etc. Birds eat fish from Koi ponds. Dogs often wander into bushes and landscaping areas. Some animals like mice often find favorite hiding places or digging places near houses or other unwanted areas. Deer often jump over fences and eat various plants.

Many of these common pests have built in fight or flight mechanisms which are triggered by their sense of touch. Vibrations, transmitted through hands, feet, claws, legs, antenna, air etc. are used to indicate a predator is nearby. Vibration or movement often triggers the fight or flight mechanism in these pests. Embodiments of pest control devices, such as those described in U.S. application Ser. No. 13/754,132, described above, may generate a series of vibrations to activate the flight or fight sense in an insect. These devices may generate forces of some type whether they may be electromechanical vibrations, pulling forces, pushing forces or any other way to generate forces or movement to repel pests in a medium. Application of these forces may not be limited to pest control but forces may be applied for other uses. These threes, often in the forms of vibrations and movement are sometimes needed to be transferred to a plant, tree, branch or other medium to help ward off pests.

When transferring movement and vibrations into surfaces, a significant amount of force may be required to generate movement in something like a tree and this three may cause damage. Fruit pickers apply a considerable amount of force and are used to shake trees for fruit picking and often cause bark damage. Devices like fruit pickers are not designed to apply force for a long period of time to repel pests. They are used for a very brief period of time just to shake off fruit. Typically the application of force is completed in just a few minutes. In fruit pickers, the vibrations are removed very quickly as the continued application of force over a long period of time would cause extensive damage and wear on the tree it is attached to. Both portable devices for fruit picking and larger fruit picking devices also have some type of support system to support their weight on the ground as their weight is much larger than can be supported by the plant they are shaking. Because they are supported by the ground, the tree or plant they are attached to doesn't have to support the weight of the vibration device.

To be effective as a pest control device, the device must stay on the plant or tree for a long period of time to repel pests. Devices for pest control may be mounted to a tree or plant in the same spot for a long period of time. Extensive application of force applied to the same spot over a long period of time can cause the bark of the tree or plant to wear. The long periods of attachment may also cause girdling of limbs and branches. Because the device repels pests over a long period of time, many fruits and vegetables may be grown without chemicals. These devices provide an entirely new way of growing food organically that is safe for people. This is considered by some to be a new field of Integrated Pest Management.

Generating vibrations to ward off pests and applying force becomes especially difficult when the surface to vibrate has a soft bark such as a peach tree. When trying to vibrate a peach tree, any slippage of a vibrating device may often cause the device to wear right through the soft bark if the device is attached long enough to the same spot. Often, anything left attached to the outside of a tree can cause girdling. Girdling strangles the tree keeping nutrients from helping teed the tree to grow. When a vibrating device is left on a tree for a long period of time it can cause significant damage and this invention details a mounting method/apparatus to avoid damage.

Plant damage was measured over a long period of time. Damage to the plants was observed in various degrees. Damage correlated with surface area of the rubber pads in contact with the plant surface; the hardness of the rubber pads and the amount of force applied by the vibration apparatus to the plant. In order to be successful in warding off pests, a wide variety of vibrations at various amplitudes is required and was tested. These varying vibrations can cause significant damage to the plant surface. Trials were conducted with a larger hard rubber pad glued to the surface of the vibration device. Even with larger rubber pads, after extensive testing with vibration and or force levels that were high enough to generate vibrations in the tree branches, slippage caused the device to begin to wear down the plant surface. Slippage was a major contributor to plant damage as vibrations were applied over a long period of time. The amount of time the force was applied at one location on the plant surface also was determined to be a major factor in the damage. Over time, hard rubber pads would actually function almost like sand paper on the surface of plants. Bark was often worn off in spots where hard pads were used.

### BRIEF DISCLOSURE

The present invention is for an apparatus and method to apply force to a medium which does not damage or limits damage to the medium to which the force is applied over any period of time. The invention incorporates materials to enable operation under outdoor environmental conditions while applying force over any period of time. The invention maximizes the surface area where force is applied in/on a medium to spread force over a more uniform area. Slippage is reduced on the surface of a medium that the force is applied to. By moving the likely slipping point away from the surface of the medium slippage is further reduced. Increasing the number of connection points/and or surface area of a single connection enable forces to be spread out to decrease damage from the force application. Devices that incorporate this invention may be connected to a medium without external support and may stay connected applying force over any period of time.

An exemplary embodiment of an apparatus for repelling pests horn an object includes a vibration generator. The vibration generator is operable to produce a plurality of vibrations. A mounting apparatus is configured to secure the vibration generator to the object to transfer the plurality of vibrations from the vibration generator to the object. The plurality of vibrations transferred to the object repels pests from the object.

An exemplary embodiment of a method of repelling pests from an object include winding a wrap at least once around an object to be vibrated. A mounting apparatus is secured to a vibration generator, the vibration generator operable to produce a plurality of vibrations. The wrap is engaged with the mounting apparatus to indirectly secure the vibration generator to the object. A plurality of vibrations are produced with the vibration generator. The plurality of vibrations transferred from the vibration generator to the object through the wrap.

An exemplary embodiment of a mounting apparatus for securing a vibration generator to an object to be vibrated to repel pests from the object includes a wrap. The wrap is configured to be wound at least once around the object to be vibrated. A strap is secured about the vibration generator and the object to be vibrated such that the vibration generator is secured to the object to be vibrated at the wrap. The mounting apparatus is configured to be secured to the vibration generator and secured to the object to be generated. The mounting apparatus is operable to transfer a plurality of vibrations from the vibration generator to the object to be vibrated without damage to the object to be vibrated.

### BRIEF DESCRIPTION OF THE DRAWINGS

FIG. 1 depicts an embodiment of a vibrating device and an embodiment of an apparatus for force transfer.

FIG. 2 is a front perspective view of an exemplary embodiment of a tree wrap.

FIG. 3 depicts an exemplary embodiment of a method by which a vibrating is secured to an object.

### DETAILED DESCRIPTION

Embodiments disclosed herein solve the problem of being able to mount a device to a plant, tree or other medium without causing damage to the medium. Through extensive testing of pest control vibration generation devices, it has proven extraordinarily difficult to attach a vibration generation device to a plant, tree, or branch that transfers a movement for a significant period of time without causing damage. Embodiments mount a vibration device to minimize and or eliminate damage done to a tree, plant, branch or other medium when operably transferring forces to a tree; plant, branch or other surface exemplarily to ward off pests that are sensitive to vibrations.

Exemplary embodiments combine a method of supporting the weight of a pest control device with a method of safely transferring vibration or movement to the plant, tree, branch or other surface. Elements of this embodiment of the invention are used to transfer vibrations, minimize or eliminate damage, and temporarily or semi temporarily hold the device so that the desired movement or force may be effectively transferred.

In a non-limiting embodiment of this invention, an outdoor, sunlight resistant, resilient, extremely tough elastomeric (e.g., regular) strap is used to hold a vibration generation device to a tree, plant, or other object to be vibrated. A device is attached to the plant as a pest deterrent or even for a pollination stimulator in plants such as tomatoes. The elastomeric strap provides a removable but resilient means of attaching the device to the medium and prevents or limits the device movement, without translating this movement to the object. The device itself may have a wide variety of configurations in-between the device and the medium is an outdoor, sunlight resistant, resilient, extremely tough elastomeric wrap. This wrap is wrapped around the circumference of the branch, tree, plant or medium to be vibrated. The strap holds the vibration device to the wrap which is wrapped around the trunk of a tree or branch. The wrap then transfers the vibrations from the vibration device to the tree, branch or plant. The unique combination of a vibration/movement apparatus, a method of weight support (the strap) and a method of limiting damage (the wrap) is not readily apparent to someone knowledgeable in pest control. What further makes this unique is the ability of this and other embodiments to minimize damage to the medium and at the same time maximizing the magnitude of vibrations transferred. Maximizing vibration transfer without damage was achieved in this non limiting embodiment by maximizing the surface area in contact with the plant, tree branch, or other medium by using a very soft elastomeric wrap that had extensive elasticity.

Non-limiting examples of devices of vibration/force application for pest control are described U.S. patent application Ser. No. 13/754,132, as discussed above. Previous devices, when attached to trees and plants in various ways before the solutions disclosed herein, often did extensive damage to the object (e.g. plain or tree).

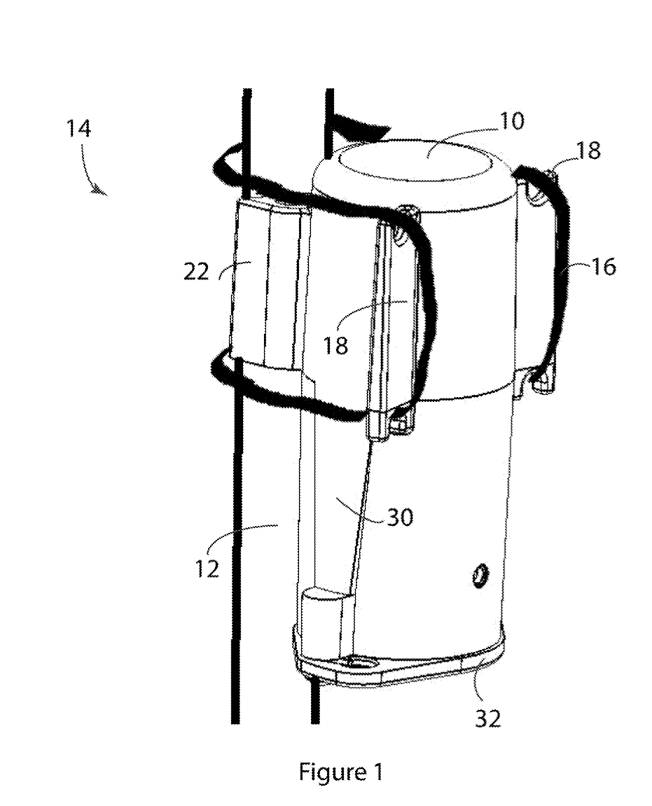

FIG. 1 shows one embodiment of the invention and shows a vibrating device 10 secured to an object 12 (e.g. a tree, plant, or branch). The vibrating device 10 is secured to the object 12 using an attachment apparatus 14 as described in further detail herein. The attachment apparatus 14 is designed to eliminate damage to the object it is attached to. The apparatus 14 includes a rubber strap 16, which is exemplarily a special grade EPDM rubber strap used to hold the vibrating device to the tree. The rubber strap 16 is looped around the vibration device and the tree it is attached to.

The rubber strap 16 serves multiple functions. The first function is to hold the weight of the device so the device does not drop to the ground. The second function is to provide a firm attachment of the device to enable the device to transfer vibrations with the desired amplitude and frequency. The strap 16 is infinitely adjustable as it may be twisted various ways to adjust the tightness of the device attached to a tree. The strap 16 in this embodiment has been specifically selected for specific properties. EPDM rubber was selected after exhaustive research into different materials. It is environmentally hardened. The EPDM makes the strap in this embodiment resistant to sunlight, strong, and very elastic to avoid permanent deformation. It provides the optimum way to attach the device to the tree. The elastic properties of the EPDM rubber also help the device to move if too much force is applied to the tree or plant thus helping to keep the tree or plant from being damaged. If the device is strapped to the tree for a long period of time and the tree it is attached to starts to grow, the elasticity of the strap will enable the strap to elongate and thus reduce the possibility of tree girdling. In this embodiment, the elasticity of the strap and the force it uses to hold the device may be adjusted by adjusting the width and length of the strap.

Additional embodiments may use various types of straps or hooks or other ways of connecting the device to the surface to which the force is applied. Embodiments may use adhesive or sticky tape or other methods of holding the device on to the surface or close to the surface. Straps may be permanently attached to the vibration device or removable or semi removable. Various embodiments may use nylon straps or ropes or other methods to hold the weight of the device. In this embodiment, the EPDM Rubber strap is completely removable allowing for basically an unlimited number of adjustments. By allowing for easy adjustment, users may conveniently move the device more often thus reducing the possibility of damage and girdling of limbs and branches.

In an exemplary embodiment, the rubber strap 16 is secured to the vibrating device 10 by at least one cleat 18, and exemplarily a pair of cleats. The rubber strap 16 is looped around or otherwise tied to a first cleat IS, secured around the object 12 (and tree wrap as described above), and looped around or otherwise secured to a second cleat 18.

As described in further detail herein, a junction of the apparatus and tree wrap further holds the vibration device to the object. Other embodiments may incorporate the weight holding function performed by the tree wrap by utilizing hooks to hang or hold the device like a pendulum or to spread the device weight amongst multiple branches or surfaces. In those embodiments, the branches may also provide the elasticity to help devices to transfer vibrations without damage.

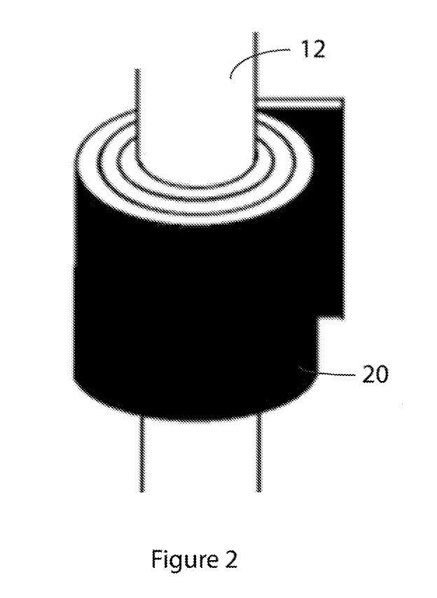

FIG. 2, depicts an exemplary embodiment of a tree wrap 20 secured around an object 12 to be vibrated. In this embodiment, the tree wrap 20 is a special grade Neoprene rubber secured around a tree transfers vibrations from a vibration apparatus. In the embodiment depicted, the tree wrap 20 is wound in a plurality of layers about the object 12.

Early attempts to transfer vibrations through various methods were explored and these were not able to provide a universal product that transferred vibrations without causing damage to plants. This feature embodiment is in direct opposition to the thoughts of the mechanical engineers and those skilled in the art of vibration transfer. Most early attempts were to transfer vibrations and attach the vibration device to a tree were made using hard rubber pads. Conventional wisdom was to use hard rubber pads to maximize the effectiveness of vibrations. Engineers indicated harder rubber was required so that vibrations were effectively transferred, from the vibration device to the plant or tree being vibrated.

Embodiments using the soft rubber wrap 20 achieve a number of benefits. The first aspect maximizes the surface area in contact with the plant. Other embodiments may spread the force over multiple contact points to maximize the surface area in contact with a plant, Maximizing the area of contact with the plant using a tree wrap spread the force out over a much larger area. In testing, spreading vibrations over areas of smaller than one quarter inch square resulted in quick damage. Applying vibrations to small areas of small plants with soft skin like tomato vine often yielded damage as well. This embodiment minimizes damage and maximizes force transfer by wrapping around the entire circumference of the plant the device is attached to. By increasing the width of the wrap, the surface area in contact may be increased drastically.

As noted previously, it was thought that the harder rubber was need to effectively transfer vibrations to the plants. While not readily apparent to those practiced in the field, very soft neoprene rubber was used in this embodiment to maximize vibration application the target. The neoprene rubber combines very tough outdoor environmentally resistant qualities with an extreme resilience. Neoprene rubber is resistant to sunlight. It is water resistant. Long term compression does not deform neoprene rubber. The very soft rubber provided a much better gripping surface to the plant it is attached to and eliminated the tendency for the material to slide across the surface of the plant. By eliminating any hard materials the slip and friction was eliminated between the surface of the plant and the vibration device attached to it. By eliminating the frictions and slip, damage was also eliminated.

Use of the neoprene wrap actually served to maximize vibration transfer to various surfaces though its extreme elasticity. Since the vibration device used generated various different levels of vibrations, the elasticity of the wrap provided maximum force transfer and also resulted in some resonant vibrations frequencies of the combination to be hit.

The softness of the neoprene wrap also provided an easy way to transfer force from the vibration device to the tree wrap itself making the mounting more flexible and easy to produce.

While one embodiment of this element may consist of gluing a pad on the surface of the vibration device, this may not be effective unless the Pad is very soft and maximizes the area to which the force is applied. Various other embodiments may apply force be hanging devices to connecting them through multiple connection points.

Another unique embodiment of the concept to spread force spread is to lower the force applied by each vibration device and use multiple smaller vibration devices to essentially spread the equivalent force to apply movement to multiple point and again decentralizing the forces applied. Essentially this amounts to dividing the force applied over a larger area.

Referring to FIG. 2, by employing a method of applying the force through a tree or branch using a wrap, the wrap provides a way to move the force vector of the applied force. FIG. 2 shows how the tree is wrapped several times round the tree. Conventional wisdom was to apply one layer of hard rubber between the object to transfer maximum amount of force to the medium to be vibrated. By wrapping the rubber guard several times around the circumference of the tree the vibration device is attached to, the torque applied to the tree by the vibrating device will increase as the distance between the device and the tree increases. By increasing the distance between the device and the tree, the amount of vibration may be adjusted by the end user. Thus in this embodiment implemented using the wrap, there is a way to adjust the torque to be applied while enabling, that torque to be applied in a safe and effective manner. The way to increase the torque is to increase the thickness of the wrap.

The neoprene rubber between the device and the tree or medium in this embodiment also allows slippage to occur, if anywhere within the neoprene rubber wrap. The force of friction proved to be one of the extremely detrimental forces to the plants in early versions. Friction often would wear the surface of the plant to the point of wearing it thin. The wrap enables the surfaces to slip somewhat when forces become too great giving a sort of safety valve which further protects the plant from damage. With the wrap used in this embodiment, the slipping point, if slip is to occur, is moved away from the surface of the plant to be vibrated. The slip occurs in the layers of the wrap rather than on the plant surface. This further lessened the possibility of damage to the plant.

The wrap in this embodiment may be cut or stretched to provide infinite adjustments.

Other embodiments may consist of a variety of methods and ways to secure the device to the surface to be vibrated which utilize the unique characteristics of supporting the weight of the pest control device, transferring vibrations to a plant or medium in a way designed to prevent damage to the medium and spreading the force applied over a larger areas of the medium.

Conventional wisdom was used by the inventors to initially implement a system of attachment with a few adjustments. Bucking conventional wisdom took testing many different types of installations on many types of plants. With this extensive amount of testing came the need, realization and ideas for a much more universally adjustable mounting using the strap and wrap technologies shown in this embodiment. Dining testing significant additional problems were discovered by evaluating/considering other methods of mounting a vibration device that might be solar powered. One function not evident to those skilled in testing initially, but one byproduct of easily adjustable mounting was that it allows adjustability to not block solar panels for powering.

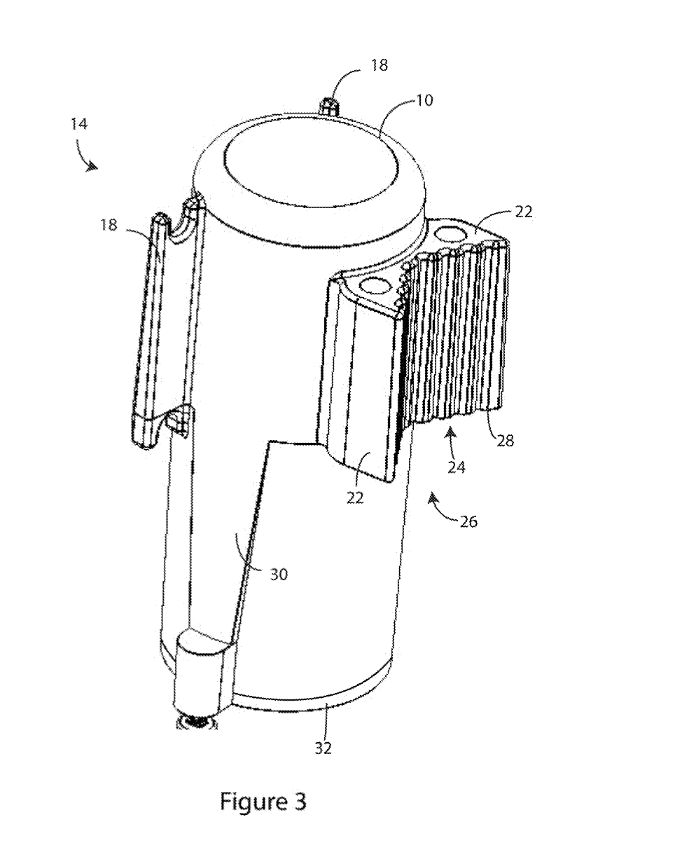

FIG. 3 depicts an exemplary embodiment of a method by which a vibrating is secured to an object. As previously described above, the object to be vibrated 12 is wrapped with a tree wrap 20. The vibrating device 10 includes a pair of mounting arms 22 which extend away from the vibrating device 10 in a direction towards the object to be vibrated 12. The mounting arms 12 exemplarily have an angle interior surface 24 that angles away from itself to the two mounting arms. This forms a mounting cradle 26 configured to engage the tree wrap 10. In still further embodiments, the angled surface 24 forming the mounting cradle 26 can be a plurality of ridges 28 which further facilitate engagement of the mounting cradle 26 with the tree wrap 20. The ridges 28 increase the surface are of engagement between the mounting cradle 26 and the tree wrap 20 which promotes transfer of vibrations and prevents slippage of the mounting cradle 26 relative to the tree wrap 20.

In use, the tree wrap 20 is wrapped around the object to be vibrated 12 and the mounting cradle 26 of the mounting apparatus 14 secured to the vibrating device 10 is pressed against the tree wrap 20. While not depicted in FIG. 3, and rather depicted in FIG. 1, a rubber strap is secured about the mounting apparatus 14, exemplarily by engaging cleats 18 positioned on the vibrating device 10.

In an exemplary embodiment, the mounting apparatus 14 further include at leas tone arm 30 depending fro the structure highlighted above the atm 30 extends down to a platform 32 positioned at a bottom of the vibrating device 10. In such an embodiment, the arm 30 and platform 32 help to secure the mounting apparatus 14 to the vibrating device 10 in a manner such as to support the weight of the vibrating device 10 with the mounting cradle 26 of the mounting apparatus 14 when secured to a tree wrap 20 around an object 12.

This written description uses examples to disclose the invention, including the best mode, and also to enable any person skilled in the art to make and use the invention. The patentable scope of the invention is defined by the claims, and may include other examples that occur to those skilled in the art. Such other examples are intended, to be within the scope of the claims if they have structural elements that do not differ from the literal language of the claims, or if they include equivalent structural elements with insubstantial differences from the literal languages of the claims.

1. An apparatus for repelling pests from an object, the apparatus comprising:
a vibration generator operable to produce a plurality of vibrations; and
a mounting apparatus configured to secure the vibration generator to the object to transfer the plurality of vibrations to the object;
wherein the plurality of vibrations transferred to the object repels pests from the object.

2. The apparatus of claim 1, wherein the mounting apparatus facilitates transfer of the plurality of vibrations to the object and protects the object from damage from the vibration generator.

3. The apparatus of claim 1, wherein the mounting apparatus further comprises:
a wrap wound at least once around the object to be vibrated; and
a strap secured about the vibration generator and the object to be vibrated such that the vibration generator is secured to the object to be vibrated at the wrap.

4. The apparatus of claim 3, wherein the wrap comprises a neoprene rubber.

5. The apparatus of claim 3, wherein the mounting apparatus further comprises at least one cleat about which the strap is secured.

6. The apparatus of claim 5, wherein the at least one cleat is at least two cleats.

7. The apparatus of claim 5, wherein the mounting apparatus further comprises at least one mounting arm forming a mounting cradle, wherein the mounting cradle engages the wrap to transfer vibrations from the vibration generator to the wrap.

8. The apparatus of claim 7, wherein the mounting cradle further comprises a plurality of ridges on an interior surface of the mounting cradle.

9. The apparatus of claim 7, wherein the mounting apparatus further comprises a platform configured to support the vibration generator the platform secured to the mounting cradle by at least one arm.

10. The apparatus of claim 1, wherein the object is selected from a list of objects consisting of a plant, a tree, and a branch.

11. A method of repelling pests from an object, the method comprising:
winding a wrap at least once around an object to be vibrated;
securing a mounting apparatus to a vibration generator operable to produce a plurality of vibrations;
engaging the wrap with the mounting apparatus to indirectly secure the vibration generator to the object;
producing a plurality of vibrations with the vibration generator; and
transferring the plurality of vibrations from the vibration generator to the object through the wrap.

12. The method of claim 11, wherein the mounting apparatus comprises a plurality of cleats and the method further comprises:
securing a strap between the plurality of cleats and the object to be vibrated to indirectly secure the vibration generator to the object to be vibrated.

13. The method of claim 11, wherein the mounting apparatus comprises at least one mounting arm forming a mounting cradle, the method comprising:
securing the mounting apparatus to the wrap at the mounting cradle, wherein the mounting cradle increases a surface area of engagement between the mounting apparatus and the wrap.

14. The method of claim 13, further comprising:
depending at least one arm from the mounting cradle, a platform secured to an end of the at least one arm; and
supporting a weight of the vibration generator with the platform.

15. The method of claim 14, wherein the weight of the vibration generator is transferred to the mounting cradle.

16. A mounting apparatus for securing a vibration generator to an object to be vibrated to repel pests from the object, the mounting apparatus comprising:
a wrap configured to be wound at least once around the object to be vibrated; and
a strap secured about the vibration generator and the object to be vibrated such that the vibration generator is secured to the object to be vibrated at the wrap;
wherein the mounting apparatus is configured to be secured to the vibration generator and secured to the object to be generated, the mounting apparatus operable to transfer a plurality of vibrations from the vibration generator to the object to be vibrated without damage to the object to be vibrated.

17. The apparatus of claim 16, wherein the mounting apparatus further comprises at least one cleat about which the strap is secured.

18. The apparatus of claim 17, wherein the mounting apparatus further comprises at least one mounting arm forming a mounting cradle, wherein the mounting cradle engages the wrap to transfer vibrations from the vibration generator to the wrap.

19. The apparatus of claim 18, wherein the mounting cradle further comprises a plurality of ridges on an interior surface of the mounting cradle.

20. The apparatus of claim 19, wherein the mounting apparatus further comprises a platform configured to support the vibration generator the platform secured to the mounting cradle by at least one arm.
